(19) United States
(12) Patent Application Publication
(10) Pub. No.: US 2009/0316459 A1
(43) Pub. Date: Dec. 24, 2009

(54) Electrical timer system that automatically operates over different supply voltages

(75) Inventors: Nick Murlo, Bloomfield, NJ (US); Buddhisagar Shah, Tarrytown, NY (US)

Correspondence Address: Paul D. Greeley;Ohlandt, Greeley, Ruggiero & Perle, L.L.P., One Landmark Square, 10th Floor, Stamford, CT, 06901-2682, US

(73) Assignee: TORK, INC.

(21) Appl. No.: 12/456,544

(22) Filed: Jun. 18, 2009

Related U.S. Application Data
(60) Provisional application No. 61/074,141, filed on Jun. 19, 2008.

(51) Int. Cl. H02M 1/10; H01H 3/26; H01H 43/04

(52) U.S. Cl. 363/142; 307/141.4; 327/520

(57) ABSTRACT

An electrical timer system is provided that has a unique voltage converter that automatically converts various supply voltage values to the required operating voltage for a timing device without jumpers or special configuration at installation.

### CROSS-REFERENCE TO RELATED APPLICATIONS

This application claims the benefit of U.S. Provisional Application No. 61/074,141, filed on Jun. 19, 2008, the contents of which are incorporated herein by reference.

### BACKGROUND OF THE DISCLOSURE

1. Field of the Invention

The present disclosure relates to an electrical timer system with a timing device that is required to operate at a fixed voltage value, but in response to a number of different supply voltages, by means of a unique voltage converter that automatically converts the different voltages to the required voltage.

2. Description of the Related Art

Timer devices are widely-used to control on/off status of various output devices, such as lights, fans, and sprinklers. The timer device is in a circuit that must accommodate the particular supply voltage that is available at the residential or commercial site. In the United States, for example, residential and commercial sites typically have supply voltages that are 120 Volts AC (VAC), 208 VAC, 240 VAC, or 277 VAC. Consequently, an installer of a timer device must carry several different timer models with him to match the supply voltage that is present at the site. Besides the inconvenience and cost of carrying several different timer models, there is the further problem that the installer may install the wrong type of timer device (i.e., a timer rated for a different supply voltage) and damage the circuits in the timer device because of excess heat generated across voltage drops. Some timer devices also lack short circuit protection to protect against overheating when the incorrect timer model is installed.

One approach to the problem is a timer device that permits an installer to select an appropriate jumper in the timer device that corresponds to the supply voltage, such as the timer described in U.S. Pat. No. 6,563,237 to Bootz. The timer device operates by routing the supply voltage through a resistor divider, and the installer selects the jumpers needed to change the resistor divider ratio. However, this timer device has the disadvantage that it still requires the installer or other end-user to properly select a jumper in the timer device to match the supply voltage, and risks damage to the device in the event of an error by the installer when selecting the jumpers.

Another approach is a timer device that employs a controller that periodically samples the values of supply voltages to protect the timer from damage when the timer is mistakenly connected to a supply voltage that is too large, such as the timer described in U.S. Pat. No. 7,245,475 to Huber. In such timer devices, when the controller senses a voltage that is so high that it could damage the relay coil, the controller permits voltage to be applied to a relay coil for only that portion of time required to energize the relay coil, but not so long that the excess voltage would damage the relay coil. The timer device routes the supply voltage through a transformer before being sent to the controller and sampled. However, the transformer wastes power, and thereby does not provide an efficient way for a timer to automatically accommodate multiple supply voltages.

Another approach has been a timer device that uses dropping resistors to adjust supply voltage. However, such timers have the disadvantage of consuming considerable amounts of power, and wasting power, both of which are contrary to the purpose of timer devices, which conserve energy by managing on/off cycles of output devices even when the person is not home.

### SUMMARY OF THE DISCLOSURE

The present disclosure provides an electrical timer system that automatically operates a timing device that is required to operate at a fixed voltage value when connected to any of several different supply voltages by means of a unique voltage converter. The electrical timer system does not require the installer or end-user to use jumpers or otherwise configure the system at installation to provide the required operating voltage for the timing device. Instead, the electrical timer system operates automatically to provide the required operating voltage for the timing device, avoids the need for a transformer, which would waste large amounts of power, by utilizing a conductive connection from the power supply to the timing device.

The electrical timer system of the present disclosure employs a unique voltage converter that automatically converts a supply voltage to the required operating voltage for a timing device. When a supply voltage exceeds the required operating voltage for the timing device in an analog timing system, the voltage converter employs a relay that controls voltage regulators, capacitors, and resistors in the circuit so that only the required voltage value is allowed to reach the timing device. The relay coil receives a rectified voltage value that is proportional to the supply voltage, and serves as the voltage sensor. In a digital timing system, an offline power converter chip is part of a voltage converter that modulates the supply voltage and converts it, as part of a circuit, to provides the required operating voltage for a digital timing device.

### BRIEF DESCRIPTION OF THE DRAWINGS

FIG. 1 is a block diagram of a control system for an electrical timer system according to an exemplary embodiment of the present disclosure.

FIG. 2 is a schematic diagram illustrating the circuitry of an exemplary embodiment of the present disclosure, for operating an electromechanical timing device.

FIG. 3 is a schematic diagram illustrating the circuitry of another exemplary embodiment of the present disclosure, for operating a digital timing device.

### DETAILED DESCRIPTION OF THE DISCLOSURE

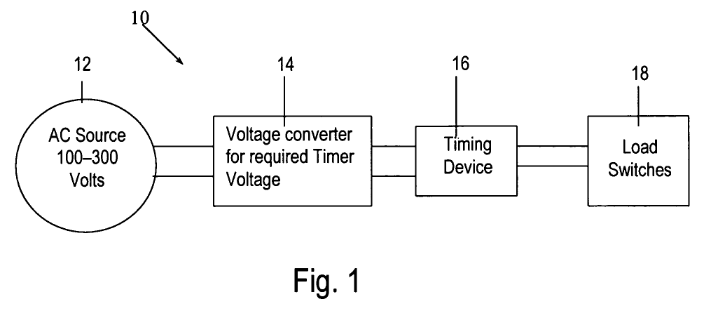

Referring now to the drawings, and in particular, FIG. 1, there is provided a block diagram of an overall electrical system 10 for an electrical timer system of the present disclosure. The system automatically converts any of several different supply voltages to a required operating voltage for a timing device.

FIG. 1 illustrates an AC Source 12 to which is connected an electrical timer system of the present disclosure. AC source 12 supplies a supply voltage (also called a “input voltage” or “mains voltage”) in electrical system 10. AC Source 12 is connected to an Automatic Converter 14, which automatically converts any of several different supply voltages from AC Source 12 to the proper operating voltage required by a Timing Device 16. Automatic converter 14 also has a voltage detection circuit that is activated when a supply voltage from AC Source 12 is any value that is different from the required operating voltage of Timing Device 16. Timing device 16 monitors time. When timing device 16 reaches a time that is pre-selected by a user, timing device 16 activates a switch that sends power to one or more Load Switches 18, which provide control of circuits to supply power to various load devices.

AC Source 12 supplies a supply voltage to an electrical timer system of the present disclosure. The electrical timer system can be connected to any supply voltage that is between about 100 Volts Alternating Current (VAC) to about 300 VAC when the timing device is an electromechanical (analog) timer, such as a timing device having a synchronous motor. The electrical timer system can be connected to any supply voltage value that is between about 90 VAC to about 300 VAC when the timing device is a digital component, such as a microprocessor. Preferably, the electrical system of the present disclosure is connected to an AC Source 12 that has one of the common supply voltages in the U.S. (120 VAC, 208 VAC, 240 VAC and 277 VAC); however, the systems of the present disclosure are able to be connected to any AC supply voltage value that is an integer or portion of an integer within the cited ranges, including all voltage values that are in between the common supply voltages found in the U.S.

Timing device 16 is one or more components that measure time, and can be an electromechanical (analog) device, digital device, or combinations thereof. Examples of electromechanical timing devices include analog clocks that are operated by a timer motor. The timer motor is a synchronous motor, a stepper motor, or any other motor that can operate a clock.

The load devices receiving power from load switches 18 can be any kind of mechanical or electrical device that the user wishes to operate at selected times. Nearly any kind of appliance or device that a user wishes to turn on-and-off at pre-selected times can be controlled by the electrical timer system of the present disclosure. Common examples of load devices include, by are not limited to, lights, fans, and sprinklers.

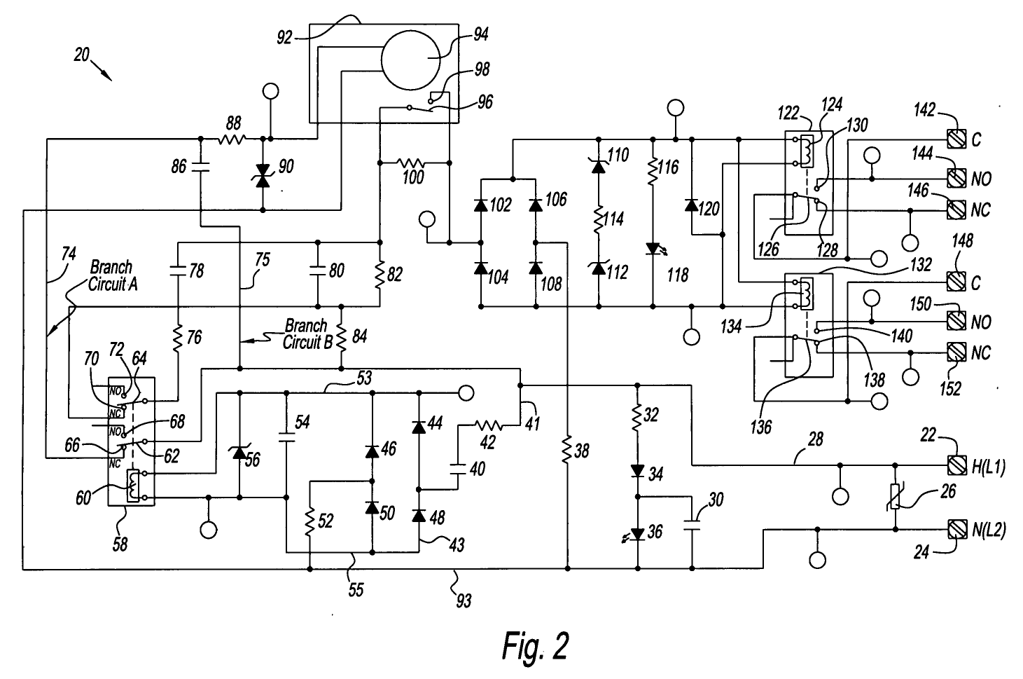

FIG. 2 is a schematic diagram illustrating the circuitry according to an exemplary embodiment of an electrical timer system that has an electromechanical (analog) timing device. An AC Source is connected to the electrical timer system at Terminal 22 and Terminal 24. Supply voltage can range from about 100 VAC to about 300 VAC, and is preferably a power source supplying 120, 208, 240, or 277 VAC to the electrical system. The current flows from Terminal 22 to device (MOV1) 26, which is a Metal Oxide Varistor and limits the supply voltage to 320 VAC maximum. The current flows by way of line 28 to an indicator circuit that has a light that goes on when the electrical timer system is powered on. The circuit includes capacitor (C5) 30, resistor (R5) 32, diode (D9) 34, and diode (LED2) 36, which can be an LED, as shown in FIG. 2, so that diode 36 is illuminated when power is on.

AC current flow continues along line 41 to capacitor (C1) 40 and resistor (R1) 42, which limit the current and voltage going into a bridge rectifier 43. Bridge rectifier 43 comprises one or more diodes that rectify the supply voltage before the current is fed to relay (K1) 58. FIG. 2 illustrates a full wave bridge rectifier 43 that comprises four diodes (D1, D2, D3, and D4) 44, 46, 48, 50; however, bridge rectifier 43 can be more than four diodes or fewer than four diodes. The AC supply voltage is converted to Direct Current (DC) by the bridge rectifier. The current is then fed to capacitor (C4) 54 and diode (TVS1) 56, which functions as a voltage regulator, before the current is fed to relay (K1) 58. Capacitor (C4) 54 is a filter capacitor that smooths the full wave DC current before the current is fed to relay 58 to energize relay coil 60. Relay coil 60 can be rated for any particular input voltage value. For example, in the embodiment in FIG. 2, relay coil 60 is rated for 24 VDC. Diode 56 is a voltage suppressor (also called a voltage suppressor or voltage clipper), and is part of a circuit that proportionately reduces supply voltage to a voltage value that is at or below the rated voltage value for relay coil 60 in relay 58. Diode 56 can be a Zener diode, or any other diode to regulate voltage. An example of a commercially-available diode 56 is the TRANSORB P6KE24A, a Transient Voltage Suppressor (Vishay Intertechnology, Inc./General Semiconductor, Shelton, Conn., USA), which has a breakdown voltage (V_{BR}) of 22.8 volts (min.) and 25.2 volts (max). The datasheet for the P6KE24A is incorporated herein by reference. Supply voltages of 208 VAC to 277 VAC are proportionately reduced by resistor (R1) 42, capacitor (C1) 40, rectified by diodes (D1, D2, D3, D4) 44, 46, 48, 50, capacitor (C4) 54, and reduced by diode (TVS1) 56 to energize the relay coil 60, and cause relay 58 to flip the moveable relay switches 62, 64.

The word “about,” as used in this application for voltages, current, dimensions, and other measures, represents a range that is ±20% of the stated value, preferably ±15% of the stated value, more preferably ±10% of the stated value, and most preferably is ±5% of the stated value, including all subranges therebetween. For example, an AC voltage that is about 120 VAC can encompass a range from 102 VAC (i.e., 120 VAC−15%) to 132 VAC (i.e., 120 VAC+10%). Nominal 120 VAC is a Root Mean Squared (RMS) value with a peak voltage of 170 VAC.

The supply voltage, having been rectified and proportionately reduced in voltage value, is fed to relay coil 60 that is in relay 58. Relay 58 includes one or more relay switches. Relay 58 is selected from the group of relays consisting of: single pole-single throw, single pole-double throw, double pole-single throw, and double pole-double throw, and any combinations thereof. In FIG. 2, relay 58 is shown as a double pole-double throw relay; however, relay 58 may have more than two poles and/or more than two throws. Relay 58 has relay coil 60, a first relay switch 62 that is connected to the contact that is shown as Normally Closed (NC) 66 or to the contact that is shown as Normally Open (NO) 68. Similarly, a second relay switch 64 in relay 58 is connected to a contact that is NC 70 or NO 72. Relay 58 functions as a voltage detecting element. The DC voltage across relay coil 60 in relay 58 is proportional to the supply AC voltage. For a DC coil relay, such as relay coil 60, poling voltage is about 75% of operating voltage. The coil operating voltage functions as a sensor, as the relay coil 60 is either energized or de-energized.

When relay coil 60 is not energized/activated, first relay switch 62 and second relay switch 64 are in their Normally Closed (NC) positions 66, 70, respectively. When supply voltage applied at Terminal 22 is nominal 120 VAC (i.e., 102 VAC to 132 VAC), the DC voltage across relay coil 60 is not enough to energize the relay coil, so that first relay switch 62 and second relay switch 64 both remain in their NC positions 66, 70, respectively. However, when supply voltage applied at Terminal 22 is 208 VAC, 240 VAC, or 277 VAC, the DC voltage across relay coil 60 exceeds the actuation voltage and energizes relay 58, causing first relay switch 62 and second relay switch 64 to move to their Normally Open (NO) positions, 68, 72, respectively.

When first relay switch 62 is in the NC position 66, “Branch Circuit A” is completed. Branch Circuit A is represented by line 74, and is the circuit that controls the voltage and current that is fed to timer motor 94. The voltage that is so fed is controlled by voltage suppressor 90, which may also be called a voltage regulator.

It will be understood that voltage suppressor 90 (TVS4) constitutes the key element providing voltage conversion of a plurality of supply voltage values to a single operating voltage required for a timing device. Due to voltage suppressor 90, when the higher supply voltage values are involved such as 208, 240, or 277 VAC, the particular supply voltage presented at input to the regulator is reduced to the required operating value of 120 VAC.

Voltage suppressor 90 can be a bi-directional diode, such as a bidirectional Zener diode, that converts supply voltages to the required operating voltage for timer motor 94. An example of a voltage suppressor 90 is the TRANSORB P6KE170CA, Transient Voltage Suppressor (Vishay Intertechnology, Inc./General Semiconductor, Shelton, Conn., USA), which is a bi-directional diode having a Reverse Stand-off Voltage (V_{RWM}) of 145.0 volts, a Breakdown Voltage (V_{BR}) of 162.0 volts (min) and 179.0 volts (max). A copy of the datasheet for the P6KE170CA is hereby incorporated by reference into this application

A further AC branch circuit, “Branch Circuit B,” represented by line 75, extends by way of capacitor (C2) 86 to connect with line 74. In the case of switch contact 66 of relay (K1) 58 being in the NC position, the capacitor (C2) 86 is non-operative. The result is that only resistor (R2) 88 is effective at the input to the timer motor 94. However, when the two higher voltages exist at the AC mains input, the relay coil 60 shifts switch 66 to the NO position, whereby line 74 of Branch Circuit A is disconnected from AC power and only line 75 is connected to the AC voltage such that capacitor (C2) 86 is operative in series with resistor (R2) 88 to affect the input to the parallel connection of voltage suppressor 90 and timer motor 94, and, where supply voltages are either 208 VAC, 240 VAC, or 277 VAC, to convert such values to the required operating voltage (120 VAC) for timer motor 94. Line 93 completes the circuit from timer motor 94 back to Terminal 24 (L2—Neutral).

When a supply voltage of 120 VAC is being received, for example, relay coil 60 is not energized due to an ineffective voltage across Zener diode 56, so only resistor (R2) 88 is effective for transmitting that particular value of voltage for timer motor 94; relay switch 62 being normally closed.

However, when supply voltage has a value of 208 VAC, 240 VAC, or 277 VAC, relay coil 60 is actuated/energized, and first relay switch 62 moves to its NO position 68. This provides one or more components that automatically regulate voltage and current provided to timer motor 94. In the exemplary embodiment shown in FIG. 2, the voltage and current provided to timer motor 94 are controlled by capacitor (C2) 86, resistor (R2) 88, and voltage suppressor (TVS4) 90.

An electrical timer system of the present disclosure automatically provides the required voltage and current to operate timer motor 94, and to the one or more output (load) devices, for a supply voltage that is 120 VAC, 208 VAC, 240 VAC, 277 VAC, and/or any other value for supply voltage between about 100 VAC and about 300 VAC.

For the electromechanical timer illustrated as an exemplary embodiment in FIG. 2, the automatic converter element is provided by operation of capacitor 86, resistor 88, and diode 90, and the control of these components by relay 58 via Branch Circuit B.

Timer module 92 has timer motor 94 and timer relay switch 96. Timer motor 94, in an exemplary embodiment, is a synchronous motor. Timer motor 94 follows the supply frequency at 60 Hz, much like commercial AC clocks. Timer relay switch 96 has an open position (as shown in FIG. 2) and a closed position 98. When timer relay switch 96 is in closed position 98, power is sent to one or more load devices.

When timer relay switch 96 is in its closed position, thereby completing a circuit, AC power is sent to load devices (not seen) by methods that are known in the art. However, as illustrated in FIG. 2, AC power is sent through a bridge rectifier that includes diodes (D5 D6 D7 D8) 102, 104, 106, 108, to furnish power to operate relay coils 124, 134, connected to ground after passing through resistor (R10) 38, then one or more voltage limiting diodes (shown in FIG. 2 as Zener diodes 110, 112), resistors (R3 R4) 114, 116, an LED diode (LED1—red) 118, and another diode (D10) 120. From there, power is sent to one or more relays, illustrated in FIG. 2 as a first output relay (K2) 122, and a second output relay (K3) 132. First output relay 122 is a relay selected from the group consisting of: single pole-single throw, single pole-double throw, double pole-single throw, and double pole-double throw, and any combinations thereof. As illustrated in the exemplary embodiment in FIG. 2, first output relay 122 is a single pole-double throw relay. First output relay 122 has a first output relay coil 124 and a first output relay switch 126 that is connected to a contact that is Normally Closed (NC) 128 or to a contact that is Normally Open (NO) 130. First output relay coil 124 is rated for 48 Volts DC. When first output relay coil 124 is not in use, or has not received enough voltage to be actuated, first output relay switch 126 is in the NC position 128, and completes a circuit to Terminal 146, which is marked NC in FIG. 2. When first output relay 122 is actuated, first output relay switch 126 moves to the NO position 130 to complete the circuit to Terminal 144, marked NO in FIG. 2.

Similarly, second output relay 132 is a relay selected from the group consisting of: single pole-single throw, single pole-double throw, double pole-single throw, and double pole-double throw, and any combinations thereof. As illustrated in the exemplary embodiment in FIG. 2, second output relay 132 is a single pole-double throw relay. Second output relay 132 has a second output relay coil 134 and a second output relay switch 136 that is connected to a contact that is Normally Closed (NC) 138 or to a contact that is Normally Open (NO) 140. Second output relay coil 134 is rated for 48 Volts DC. When second output relay coil 134 is not in use, or has not received enough voltage to be actuated, second output relay switch 136 is in the NC position 138, and completes a circuit to Terminal 152, which is marked NC in FIG. 2. When second output relay 132 is actuated, second output relay switch 136 moves to NO position 140 to complete the circuit to Terminal 150, marked NO in FIG. 2.

In this manner, the electrical timer system of the present disclosure is able to regulate power sent to one or more output (load) devices with a single timing device.

An electrical timer system of the present disclosure that is an electromechanical timer does not require any jumpers to accommodate the various supply voltages at a given site, nor does an electrical timer system be configured by the user at installation to accommodate the particular supply voltage that is present at the residential or commercial site.

In addition, an electrical timer system of the present disclosure automatically provides the required operating voltage to the timer motor without employing a transformer, thereby avoiding heat loss and other wasting of power associated with transformers.

Under normal operating conditions, an electrical timer system of the present disclosure consumes less power in standby mode as compared with conventional timers. An electrical timer system of the present disclosure preferably consumes less than 1 watt of supply power in standby mode. The timers use less supply power than those using transformer power supplies, and have less power wastage in standby mode under normal operating conditions.

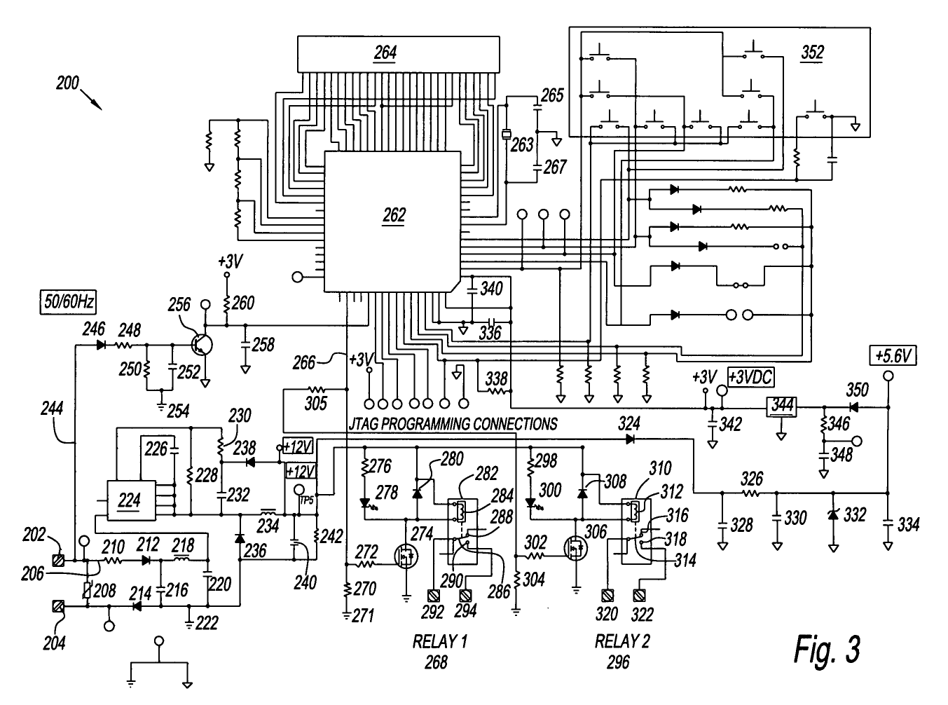

For a digital timer, FIG. 3 illustrates an exemplary embodiment of an electrical timer system that has a digital timer. An AC Source is connected to the electrical timer system at Terminal 202 (marked Line 1) and Terminal 204 (marked Line 2, Neutral). Supply voltage can range from about 90 VAC to about 300 VAC, and is typically an AC power source supplying 120, 208, 240, or 277 VAC into the electrical system.

Supply voltage from Terminal 202 (Line 1) passes along the circuit line marked 206 to Metal Oxide Varistor (MOV1) 208, resistor (R1) 210, diode (D1) 212, capacitor (C1) 216, diode (D3) 214, Inductor (L1) 218, capacitor (C2) 220, thence to ground 222.

Power then flows to offline power converter 224, which is an integrated circuit chip that modulates voltage and converts it. Offline power converter 224, in conjunction with Inductor (L2) 234, which serves as a choke, end up with a DC voltage at capacitor (C6) 240 that is 12 VDC at TP5 (test point 5). Offline power converter 224 can accommodate supply voltages from about 90 VAC to about 300 VAC, which is a slightly larger range as compared with the embodiment having an electromechanical timer (illustrated in FIG. 2), as offline power converter 224 is more tolerant of incoming AC voltages and can modulate a somewhat larger range of them to the required operating voltages used by the timer (in this embodiment, microprocessor 262).

The electrical timer system illustrated in FIG. 3 has a digital microprocessor 262 that is the operating logic for the operating electronics in this exemplary embodiment. LCD DISPLAY 264 provides a visual display of the time and programs.

In the exemplary embodiment of the digital timing device in FIG. 3, the timing device is internal to microprocessor 262. That is, the timer is in software within the microprocessor 262. Timing crystal (X1) 263 is a crystal that is the system clock, and provides information on timing to microprocessor 262.

Additional data used by microprocessor 262 for accurate timekeeping is fed into microprocessor 262 from transistor 256 and the other components nearby including diode (D2) 246, resistor (R3) 248, resistor (R2) 250, capacitor (C3) 252 (that are connected to ground 254), resistor (R15) 260, and capacitor (C11) 258. A 50/60 Hz signal is sent to microprocessor 262 to keep accurate time. A pulse at TP3 (test point 3) at the 50/60 Hz edge is processed by microprocessor 262 to keep accurate time.

From the microprocessor 262, power is sent at the pre-selected times programmed by the user to output devices that are regulated by one or more output relays, labeled as RELAY 1 and RELAY 2 in FIG. 3.

The electrical timer system that is a digital timer is more eco-friendly than conventional timers because of component selection, in conjunction with offline power converter chip 224, which consume less than 0.5 watt when the device is in standby mode. For many conventional timers, particularly those containing transformers, the efficiency is far less, as such timers are losing about 20% of power as heat. The electrical timer systems of the present disclosure do not use transformers, and so have little power wastage or power losses in standby mode.

Short circuit protection in the digital timer embodiment is internal to offline power converter 224. In this exemplary embodiment, short circuit protection is thermal shutdown circuitry that senses die temperature, and disables a MOSFET switch above a certain die temperature, and restores operation of the switch when die temperature drops a predetermined amount.

It should be understood that the foregoing description is only illustrative of the present invention. Various alternatives and modifications can be devised by those skilled in the art without departing from the disclosure. Accordingly, the present disclosure is intended to embrace all such alternatives, modifications, and variances that fall within the scope of the appended claims.

What is claimed is:

1. An electrical timer system that can be connected to an AC power source supplying a supply voltage, comprising:
a timing device;
a voltage converter, wherein said voltage converter automatically converts a plurality of supply voltage values to a correct operating voltage required to operate said timing device, and
wherein there is a conductive connection between the supply voltage and said voltage converter.

2. The electrical timer system according to claim 1, wherein the supply voltage is between about 100 volts AC and about 300 volts AC.

3. The electrical timer system according to claim 1, wherein said timing device is an electromechanical timer.

4. The electrical timer system according to claim 3, wherein said voltage converter includes a bidirectional diode, and functions as a voltage regulator.

5. The electrical timer system according to claim 1, wherein said electromechanical timer system further comprises a timer motor that is a synchronous motor.

6. The electrical timer system according to claim 4, further comprising:
a first AC branch circuit and a second AC branch circuit, wherein said first branch circuit and said second branch circuit are connected to a common point at the input to said voltage regulator;
wherein said second branch circuit has a capacitor connected to said common point and said first branch circuit is directly connected to said common point.

7. The electrical timer system according to claim 6, further comprising:
a switch;
wherein activation of said switch causes disconnection of said first branch circuit, such that said capacitor in said second branch circuit is connected to said voltage regulator.

8. The electrical timer system according to claim 1, wherein said timing device is a digital timer.

9. The electrical timer system according to claim 8, wherein said digital timer is part of a microprocessor.

10. The electrical timer system according to claim 8, wherein said converter system is a digital offline power converter.

11. The electrical timer system according to claim 10, wherein said digital offline power converter is a microprocessor, and
wherein said microprocessor internally monitors supply voltage, internally rectifies the supply voltage, and internally reduces the supply voltage to the required operating voltage of said digital timer.

12. The electrical timer system according to claim 9, wherein said digital timer keeps accurate time by processing information received by said microprocessor from a crystal that is a system clock and from a pulse that is generated at an edge of a 50/60 Hz test point.
